(19) United States
(12) Patent Application Publication
(10) Pub. No.: US 2015/0310324 A1
(43) Pub. Date: Oct. 29, 2015

(54) RADIO FREQUENCY IDENTIFICATION TAG AND LOW DROPOUT REGULATOR (LDO) CIRCUIT CONSUMING ULTRA-LOW POWER

(71) Applicants: EXCELIO TECHNOLOGY (SHENZHEN) CO., LTD., Shenzhen (CN); WUXI EXCELIO TECHNOLOGY CO., LTD., Wuxi (CN)

(72) Inventors: Patrick Bian Wu, Shenzhen (CN); Wei Xu, Shenzhen (CN); Fuqiang Han, Shenzhen (CN); Shehu Qi, Shenzhen (CN); Yuanming Luo, Shenzhen (CN)

(73) Assignees: EXCELIO TECHNOLOGY (SHENZHEN) CO., LTD.; WUXI EXCELIO TECHNOLOGY CO., LTD.

(21) Appl. No.: 14/794,049

(22) Filed: Jul. 8, 2015

Related U.S. Application Data
(63) Continuation-in-part of application No. PCT/CN2013/073893, filed on Apr. 8, 2013.

(30) Foreign Application Priority Data
Jan. 9, 2013 (CN) 201310009385.3

(51) Int. Cl. G06K 19/07; G05F 1/56

(52) U.S. Cl. CPC G06K 19/0701; G05F 1/56; G06K 19/0723

(57) ABSTRACT

A radio frequency identification (RFID) tag and a low dropout regulator (LDO) circuit consuming ultra-low power. The circuit is connected to a first threshold unit and a second threshold unit respectively and in series at a first voltage dividing resistor (R1) bypass and a second voltage dividing resistor (R2) bypass; utilizes the inherent threshold property of a unidirectional conductive diode or a MOS tube in the threshold units, and the voltage difference between the positive input terminal of an error-correction differential amplifier and a voltage output terminal (Vout), and the voltage differences between the voltage of the positive input terminal to the voltage output terminal and the voltage of the positive input terminal to a ground wire terminal of the error-correction differential amplifier are respectively borne by the threshold units; therefore, the remaining voltage on a resistor connected in the circuit in series will be a small value, thus effectively reducing the power consumption of the resistor. Furthermore, compared with a normal structure using a resistor alone, the structure connecting a diode or an MOS tube in series in a resistor bypass can greatly reduce the overall area of a chip under the same power consumption, thus reducing cost.

### CROSS-REFERENCE TO RELATED APPLICATIONS

This application is a continuation-in-part of International Patent Application No. PCT/CN2013/073893 with an international filing date of Apr. 8, 2013, designating the United States, now pending, and further claims priority benefits to Chinese Patent Application No. 201310009385.3 filed Jan. 9, 2013. The contents of all of the aforementioned applications, including any intervening amendments thereto, are incorporated herein by reference.

### TECHNICAL FIELD

The present invention relates to the field of radio frequency identification technology, in particular to a low-dropout regulator circuit with ultra-low power consumption, and a radio frequency identification tag including the low-dropout regulator circuit.

### BACKGROUND OF THE PRESENT INVENTION

Low-dropout regulator (LDO) circuit modules have been widely applied in the filed of integrated circuit chips, mainly to regulate the input power supply voltage through a high-gain error-correction differential amplifier, a power transistor and a negative feedback loop, output the regulated power supply voltage, and effectively suppress the disturbance and noise, caused by the input power, within the frequency range of the negative feedback loop per unit of gain bandwidth, thus to provide ideal power to loads on the chip. The circuit diagram is as shown in FIG. 1.

The low-dropout regulators have the following characteristics: when the input power supply voltage decreases to have a small difference from the output power supply voltage, duo to the loop gain effect of the negative feedback loop, the output power supply voltage can maintain a good stability, without changing with the input power supply voltage. This is especially important for mobile devices powered by batteries.

The voltage (Vout) output by the low-dropout regulator circuit is determined by the reference voltage (Vref) input by the negative input end of the error-correction differential amplifier, and by a ratio of the resistance (R1) from the output end of the low-dropout regulator circuit to the positive input end of the error-correction differential amplifier to the resistance (R2) from the positive input end of the error-correction differential amplifier to the GND, i.e.

Vout=Vref·(1+R1/R2)

The low-dropout regulator circuit is an indispensable part of a passive radio frequency identification (RFID) tag chip. A passive RFID tag itself doesn't carry any battery, and relays on the electromagnetic energy sent by a card reader. Due to their simple structure and economically practicality, Passive RFID tags have been widely applied in the fields of logistics management, asset tracking and mobile health.

When in use, a passive RFID tag will absorb the electromagnetic energy sent by a card reader from the surrounding. After absorbing the electromagnetic energy, the passive RFID tag rectifies some of the electromagnetic energy to DC power which is input into a low-dropout regulator circuit module as an input signal, and the regulated power is output to and used by circuits internal to the passive RFID tag to work; the passive RFID tag further inputs the remaining energy to a modulation and demodulation circuit. The modulation and demodulation circuit demodulates an amplitude modulation signal carried in the energy and sends the demodulated signal to a digital baseband portion of the passive RFID tag for processing. Duo to the characteristic that the passive RFID tag is not powered by batteries, it can't work until the consumed power consumption reaches an extremely small extent. This proposes high design requirements of low-power consumption to designs of all circuit modules on the passive RFID tag chip.

The power consumption of the low-dropout regulator circuit is roughly attributed to the error-correction differential amplifier and the voltage dividing resistors (R1 and R2). When the current of loads driven by the low-dropout regulator circuit becomes the minimum, that is, in the case of zero-load, power consumption by the above two parts still exists. The low power consumption design of the error-correction differential amplifier itself is not within the scope of problems to be solved by the technologies disclosed in the present application. The present application provides an implementation way to reduce the power consumption on the voltage dividing resistors in the low-dropout regulator circuit.

The power consumption on the voltage dividing resistors in the low-dropout regulator circuit is determined by the reference voltage Vref and the resistance (R2) from the positive input end of the error-correction differential amplifier to the GND. The current flowing through the resistor R2 is:

IR₂=V_{ref}/R2

where, the typical value of V_{ref} is 1.0V; and, in a passive RFID tag, in order to achieve the requirement of low power consumption, if the current set on this branch is 100 nA, the desired resistance R2 will be 1.0V/100 nA=10 MΩ. For example, for a logical process of 0.18 μm, the square resistance of ordinary polysilicon resistors is 10 ohm/square, and a resistor having a resistance R2=10 MΩ will occupy one million squares. If the output voltage of the low-dropout regulator circuit is set as 1.8V, then, R1=8 MΩ, that is, the resistor R1 needs more than 0.8 million squares. The minimum width of resistors according to the 0.18 μm process is 500 nm, and the total 1.8 million squares will occupy an area of 0.5 μm*0.5 μm*1800000=0.45 mm². If non-ideal factors caused by elimination of process deviation are taken into consideration, a size greater than the minimum 500 nm will be selected as the unit size of the 1.8 million squares. Then, the sum of area of the two resistors will multiply, so that the design of the low-dropout regulator circuit can not satisfy the design requirement of low cost.

### SUMMARY OF THE PRESENT INVENTION

### Technical Problems

The technical problem to be solved by embodiments of the present invention is to provide a low-dropout regulator circuit with ultra-low power consumption and a radio frequency identification tag including the low-dropout regulator circuit. Under the premise of meeting the present circuit performance achieved by pure resistor devices, the requirements of a low-dropout regulator circuit on low power consumption and low cost are realized.

### Technical Solutions

To achieve the above objective, the present invention employs the following technical solutions.

A low-dropout regulator circuit with ultra-low power consumption is provided, including an error-correction differential amplifier, an MOS transistor, a first voltage dividing resistor and a second voltage dividing resistor, a negative input end of the error-correction differential amplifier being connected to a bandgap reference voltage, a positive input end of the error-correction differential amplifier being grounded through the second voltage dividing resistor, an output end of the error-correction differential amplifier being connected to a gate of the MOS transistor, a source of the MOS transistor and a power input end of the error-correction differential amplifier being connected to a power input, respectively, a drain of the MOS transistor being connected to the positive input end of the error-correction differential amplifier through the first voltage dividing resistor;

the low-dropout regulator circuit further includes:

a first threshold unit connected between the positive input end of the error-correction differential amplifier and the first voltage dividing resistor, the first threshold unit being configured to reduce a difference in voltage from the positive input end of the error-correction differential amplifier to a voltage output end; and

a second threshold unit between the positive input end of the error-correction differential amplifier and the second voltage dividing resistor, the second threshold unit being configured to reduce a difference in voltage from the positive input end of the error-correction differential amplifier to a GND end.

The first threshold unit and the second threshold unit are diodes, or P-type MOS transistors, or N-type MOS transistors, connected in series; and the number of diodes, or P-type MOS transistors, or N-type transistors connected in series in the first threshold unit and the second threshold unit is the same.

Another objective of the embodiments of the present invention is to provide a radio frequency identification tag including the low-dropout regulator circuit as described above.

### Beneficial Effects

In the low-dropout regulator circuit with ultra-low power consumption described in the present invention, by connecting in series a first threshold unit and a second threshold unit to branches of the first voltage dividing resistor and the second voltage dividing resistor, respectively, due to the inherent threshold properties of unidirectional diodes or MOS transistors within the threshold units, that is, the difference in voltage from the positive input end of the error-correction differential amplifier to a voltage output end and the difference in voltage from the positive input end of the error-correction differential amplifier to a GND end are borne by the thresholds, the remaining voltage on the transistors connected thereto may reach a small value, so that the power consumption on the resistors is effectively reduced. Meanwhile, under the same power consumption, compared with a conventional structure using resistors alone, a structure of connecting in series diodes and MOS transistors on branches of resistors as disclosed in the present application may greatly reduce the overall area of a chip, thus achieving reduced cost.

### BRIEF DESCRIPTION OF THE DRAWINGS

To describe the technical solutions in the embodiments of the present invention or in the prior art more clearly, drawings to be used in the description of the embodiments will be introduced briefly. Apparently, the drawings hereinafter merely show some embodiments of the present invention, and a person of ordinary skill in the art may obtain other drawings according to these drawings without any creative effort.

FIG. 1 is a structural diagram of an existing low-dropout regulator circuit;

FIG. 2 is a graph of input-output characteristics of an existing low-dropout regulator circuit;

FIG. 3 is a structural diagram of a low-dropout regulator circuit used in the present invention;

FIG. 4 is a structural diagram of Embodiment 1 of a low-dropout regulator circuit used in the present invention;

FIG. 5 is a structural diagram of Embodiment 2 of the low-dropout regulator circuit used in the present invention;

FIG. 6 is a structural diagram of Embodiment 3 of the low-dropout regulator circuit used in the present invention;

FIG. 7 is a structural diagram of Embodiment 4 of the low-dropout regulator circuit used in the present invention;

FIG. 8 is a structural diagram of Embodiment 5 of the low-dropout regulator circuit used in the present invention; and

FIG. 9 is a graph of input-output characteristics of the low-dropout regulator circuit used in the present invention.

### DETAILED DESCRIPTION OF THE PRESENT INVENTION

The technical solutions in the embodiments of the present invention will be dearly and completely described as below with reference to the drawings in the embodiments of the present invention. Apparently, the described embodiments are merely some but not all of embodiments of the present invention. All other embodiments obtained by a person of ordinary skill in the art on the basis of the embodiments of the present invention without any creative effort shall fall into the protection scope of the present invention.

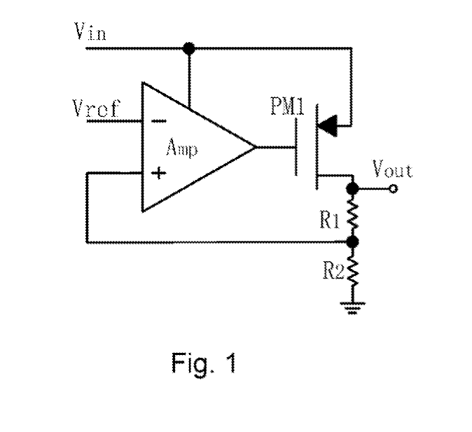

As shown in FIG. 1, a structural diagram of an existing low-dropout regulator circuit is shown. The low-dropout regulator circuit includes an error-correction differential amplifier AMP, a P-type MOS transistor PM1, a first voltage dividing resistor R1 and a second voltage dividing resistor R2. A power supply end of the error-correction differential amplifier AMP is connected to a power input Vin, a negative input end thereof is connected to a bandgap reference voltage Vref, a positive output end thereof is grounded through the second voltage dividing resistor R2, and an output end thereof is connected to a gate of the P-type MOS transistor PM1. A source of the P-type MOS transistor PM1 is connected to the power input Vin, and a drain thereof is connected to the positive input end of the error-correction differential amplifier through the first voltage dividing resistor R1. Meanwhile, the drain of the P-type MOS transistor is connected to a power output end Vout of the low-dropout regulator circuit.

The low-dropout regulator has the following characteristics: when the input power supply voltage decreases to have a small difference from the output power supply voltage, duo to the loop gain effect of the negative feedback loop, the output power supply voltage can maintain a good stability, without changing with the input voltage. The working principle of the low-dropout regulator will be described below.

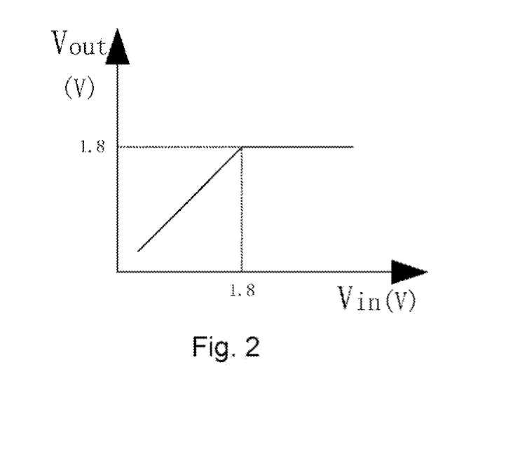

When the input voltage Vin increases, current flowing through the P-type MOS transistor PM1 increases, thus voltage across the first voltage dividing resistor R1 increases so that voltage at the positive input end of the error-correction differential amplifier AMP increases. By the amplification of the error-correction differential amplifier AMP, voltage at the output end of the error-correction differential amplifier AMP increases. That is, gate voltage of the P-type MOS transistor PM1 increases, so that gate-source voltage VGS of the P-type MOS transistor PM1 decreases. Consequently, current flowing through the P-type MOS transistor PM1 decreases and the output voltage Vout decreases. That is, the output voltage will not increase as the input voltage increases. Similarly, when the input voltage Vin decreases, duo to the negative feedback loop, the output voltage Vout increases. That is, the output voltage will not decrease as the input voltage decreases. That is, the output power supply voltage maintains a good stability, without changing with the input voltage. A graph of input-output characteristics is as shown in FIG. 2.

In the low-dropout regulator circuit, the current on the second voltage dividing resistor R2 is:

I_{R2}=V_{ref}/R2,

The power of the resistor R2 is:

P_{R2}=V_{ref}²/R2,

The current on the first voltage dividing resistor R1 is:

I_{R1}=I_{R2}=V_{ref}/R2,

The power of the resistor R1 is:

P_{R1}=I_{R1}²·R1=V_{ref}²·R1/R2².

From above, it can be seen that, if the power consumption of the resistor R2 is to be reduced, the impedance of the resistor R2 must be increased. According to Vout=Vref·(1+R1/R2), under the premise of keeping Vout and Vref unchanged, if the impedance of the resistor R2 is to be increased, the impedance of the resistor of the first dividing resistor R1 must be increased. Increasing the impedance of the resistor R1 and the resistor R2 directly results in increased overall area of a chip and further increased production cost.

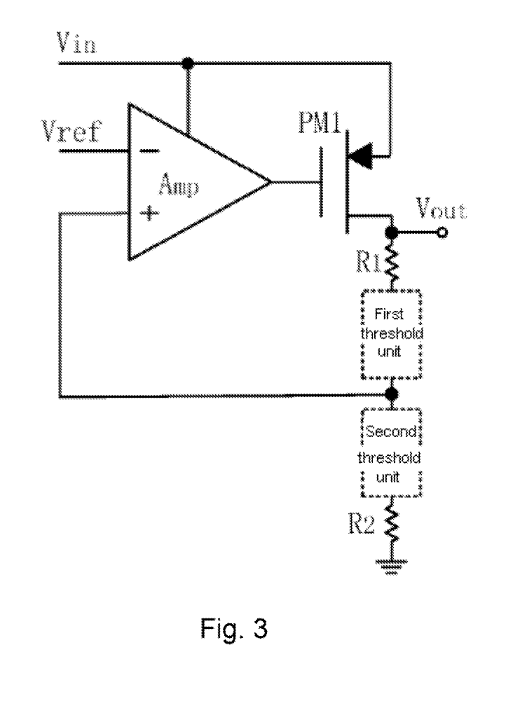

The low-dropout regulator circuit with ultra-low power consumption as described in the present invention further includes a first threshold unit connected between the positive input end of the error-correction differential amplifier AMP and the first voltage dividing resistor R1, and a second threshold unit between the positive input end of the error-correction differential amplifier AMP and the second voltage dividing resistor R2, as shown in FIG. 3. Due to the inherent threshold properties of unidirectional components within the first threshold unit and the second threshold unit, that is, the difference in voltage from the positive input end of the error-correction differential amplifier AMP to a voltage output end and the difference in voltage from the positive input end of the error-correction differential amplifier AMP to a GND end are borne by the thresholds, the remaining change in voltage on the transistors connected thereto may reach a small value. That is, the power consumption on the resistors is effectively reduced, and it is unnecessary to reduce the power consumption by increasing the impedance of the resistors. The above theory is expressed in the following formulas:

The current on the second voltage dividing resistor R2 is:

I_{R2}=(V_{ref}−Vₜₕ)R2,

The power of the resistor R2 is:

P_{R2}=(V_{ref}−Vₜₕ)²/R2,

The current on the first voltage dividing resistor R1 is:

I_{R1}=I_{R2}=(V_{ref}−Vₜₕ)/R2,

The power of the resistor R1 is:

P_{R1}=I_{R1}²·R1=(V_{ref}−Vₜₕ)²·R1/R2².

As the first threshold unit and the second threshold unit, diodes or MOS transistors having a unidirectional conduction function may be used to be connected in series between the positive input end of the error-correction differential amplifier AMP and the first and second voltage dividing resistors R1 and R2. In order to eliminate the influence caused as the threshold voltage of the unidirectional conduction components fluctuates with process parameters and drifts with temperature, the unidirectional conduction components connected in the first threshold unit and the second threshold unit should maintain strict symmetry. That is, not only the type of unidirectional conduction components is required to be the same, but also the number of unidirectional conduction components in both threshold units is required to be the same.

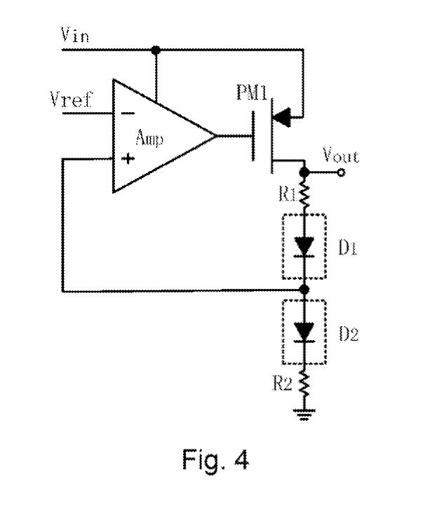

When a unidirectional conduction component used as the threshold unit is at least one diode, the connecting structure of the unidirectional conduction component is as shown in FIG. 4.

The first threshold unit is at least one diode. A cathode end of the at least one diode is connected to an anode end of an adjacent diode to form a series structure, an anode end of a first diode is connected to the first voltage dividing resistor R1 as an input end of the first threshold unit, and a cathode end of a last diode is connected to the positive input end of the error-correction differential amplifier AMP as an output end of the first threshold unit.

The second threshold unit is at least one diode, a cathode end of the at least one diode is connected to an anode end of an adjacent diode to form a series structure, an anode end of a first diode is connected to the positive input end of the error-correction differential amplifier AMP as an input end of the second threshold unit, and a cathode end of a last diode is connected to the second voltage dividing resistor R2 as an output end of the second threshold unit.

The number of diodes in the first threshold unit is the same as that of diodes in the second threshold unit. As the typical value of Vref is 1.2V (a very high value of Vref is unusual) and the typical value of threshold voltage of the diodes is 0.7V, when there are two or more diodes connected in series, a case where the value of Verf is lower than the ON voltage of the threshold unit will occur. As a result, the threshold unit can not be turned on. Therefore, only in unusual cases where the value of Vref is high, there will be more than two diodes. In the embodiments of the present invention, connection of a diode D1 and a diode D2 in series respectively to the first threshold unit and the second threshold unit is exemplified, as shown in FIG. 4.

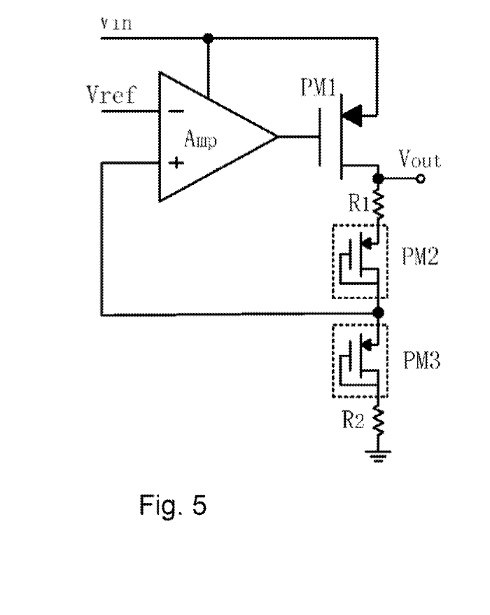

When the unidirectional conduction component used as the threshold unit is at least one P-type MOS transistor, the connecting structure of the unidirectional conduction component is as shown in FIG. 5.

The first threshold unit is at least one P-type MOS transistor. A drain end of the at least one P-type MOS transistor is connected to a source end of an adjacent P-type MOS transistor to form a series structure, a gate of each of the P-type MOS transistors is connected to a drain thereof, a source of a first P-type MOS transistor is connected to the first voltage dividing resistor R1 as an input end of the first threshold unit, a drain of a last P-type MOS transistor is connected to the positive input end of the error-correction differential amplifier AMP as an output end of the first threshold unit.

The second threshold unit is at least one P-type MOS transistor. A drain end of the at least one P-type MOS transistor is connected to a source end of an adjacent P-type MOS transistor to form a series structure, a gate of each of the P-type MOS transistors is connected to a drain thereof, a source of a first P-type MOS transistor is connected to the positive input end of the error-correction differential amplifier AMP as an input end of the second threshold unit, a drain of a last P-type MOS transistor is connected to the second voltage dividing resistor R2 as an output end of the second threshold unit.

The number of P-type MOS transistors in the first threshold unit is the same as that of P-type MOS transistors in the second threshold unit. As the typical value of Vref is 1.2V (a very high value of Vref is unusual) and the typical value of threshold voltage of the P-type MOS transistors is 0.7V, when there are two or more P-type MOS transistors connected in series, a case where the value of Verf is lower than over the ON voltage of the threshold unit will occur. As a result, the threshold unit can not be turned on. Therefore, only in unusual cases where the value of Vref is high, there will be more than two P-type MOS transistors. In the embodiments of the present invention, connection of a P-type MOS transistor PM2 and a P-type MOS transistor PM3 in series respectively to the first threshold unit and the second threshold unit is exemplified, as shown in FIG. 5.

As another embodiment of the present invention, when multiple P-type MOS transistors are connected in series in the first threshold unit, a drain end of each of the P-type MOS transistors is connected to a source end of an adjacent P-type MOS transistor to form a series structure, a source of a first P-type MOS transistor is connected to the first voltage dividing resistor R1 as an input end of the first threshold unit, a drain of a last P-type MOS transistor is connected to the positive input end of the error-correction differential amplifier AMP as an output end of the first threshold unit, and a gate of each of the P-type MOS transistors is connected to a drain of the last P-type MOS transistor; and when multiple P-type MOS transistors are connected in the second threshold unit, a drain end of each of the P-type MOS transistors is connected to a source end of an adjacent P-type MOS transistor to form a series structure, a source of a first P-type MOS transistor is connected to the positive input end of the error-correction differential amplifier AMP as an input end of the second threshold unit, a drain of a last P-type MOS transistor is connected to the second voltage dividing resistor R2 as an output end of the first threshold unit, and a gate of each of the P-type MOS transistors is connected to the drain of the last P-type MOS transistor.

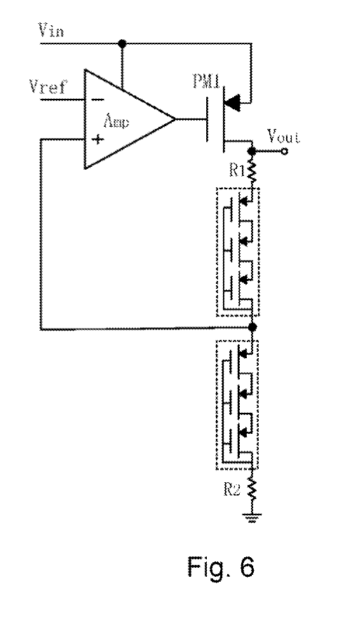

The above connecting structure, where multiple P-type MOS transistors are connected in series by their sources and drains and gates of all MOS transistors are connected to the drain of the last P-type MOS transistor, actually forms an MOS transistor having a channel of a ultra-long size, the threshold voltage thereof is still 0.7V, but the resistance thereof increases. Consequently, the value of current becomes small, and the power consumption is reduced. Moreover, the number of P-type MOS transistors in the first threshold unit is the same as that of P-type MOS transistors in the second threshold unit, as shown in FIG. 6.

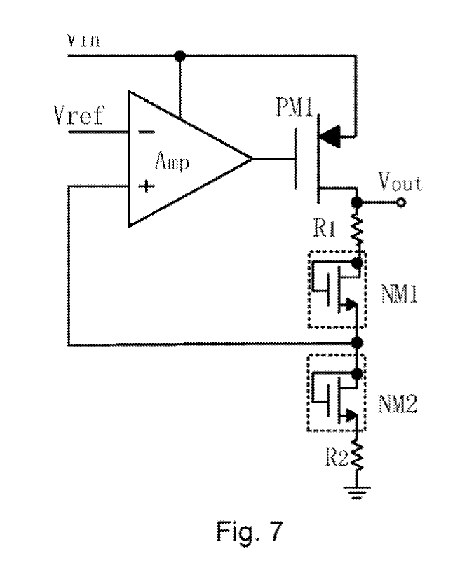

When the unidirectional conduction component used as the threshold unit is at least one N-type MOS transistor, the connecting structure of the unidirectional conduction component is as shown in FIG. 7.

The first threshold unit is at least one N-type MOS transistor. A source end of the at least one N-type MOS transistor is connected to a drain end of an adjacent N-type MOS transistor to form a series structure, a gate of each of the N-type MOS transistors is connected to a drain thereof, a source of a first N-type MOS transistor is connected to the first voltage dividing resistor R1 as an input end of the first threshold unit, a source of a last N-type MOS transistor is connected to the positive input end of the error-correction differential amplifier AMP as an output end of the first threshold unit.

The second threshold unit is at least one N-type MOS transistor. A source end of the at least one N-type MOS transistor is connected to a drain end of an adjacent N-type MOS transistor to form a series structure, a gate of each of the N-type MOS transistors is connected to a drain thereof, a source of a first N-type MOS transistor is connected to the positive input end of the error-correction differential amplifier AMP as an input end of the second threshold unit, a source of a last N-type MOS transistor is connected to the second voltage dividing resistor R2 as an output end of the second threshold unit.

The number of N-type MOS transistors in the first threshold unit is the same as that of N-type MOS transistors in the second threshold unit. As the typical value of Vref is 1.2V (a very high value of Vref is unusual) and the typical value of threshold voltage of the N-type MOS transistors is 0.7V, when there are two or more N-type MOS transistors connected in series, a case where the value of Verf is lower than the ON voltage of the threshold unit will occur. As a result, the threshold unit can not be turned on. Therefore, only in unusual cases where the value of Vref is high, there will be more than two N-type MOS transistors. In the embodiments of the present invention, connection of a N-type MOS transistor NM2 and a N-type MOS transistor NM3 in series respectively to the first threshold unit and the second threshold unit is exemplified, as shown in FIG. 7.

As yet another embodiment of the present invention, when multiple N-type MOS transistors are connected in series in the first threshold unit, a source end of each of the N-type MOS transistors is connected to a drain end of an adjacent N-type MOS transistor to form a series structure, a drain of a first N-type MOS transistor is connected to the first voltage dividing resistor R1 as an input end of the first threshold unit, a source of a last N-type MOS transistor is connected to the positive input end of the error-correction differential amplifier AMP as an output end of the first threshold unit, and a gate of each of the N-type MOS transistors is connected to a drain of the first N-type MOS transistor; and when multiple N-type MOS transistors are connected in the second threshold unit, a source end of each of the N-type MOS transistors is connected to a drain end of an adjacent N-type MOS transistor to form a series structure, a drain of a first N-type MOS transistor is connected to the positive input end of the error-correction differential amplifier AMP as an input end of the second threshold unit, a source of a last N-type MOS transistor is connected to the second voltage dividing resistor R2 as an output end of the first threshold unit, and a gate of each of the N-type MOS transistors is connected to the drain of the first N-type MOS transistor.

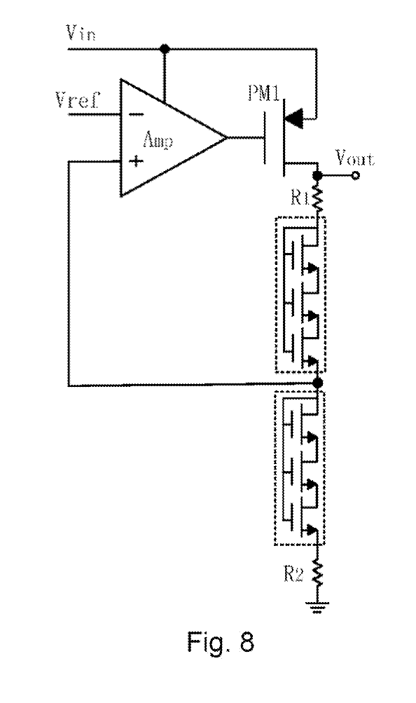

The above connecting structure, where multiple N-type MOS transistors are connected in series by their sources and drains and gates of all MOS transistors are connected to the drain of the first N-type MOS transistor, actually forms an MOS transistor having a channel of a ultra-long size, the threshold voltage thereof is still 0.7V, but the resistance thereof increases. Consequently, the value of current becomes small, and the power consumption is reduced. Moreover, the number of N-type MOS transistors in the first threshold unit is the same as that of N-type MOS transistors in the second threshold unit, as shown in FIG. 8.

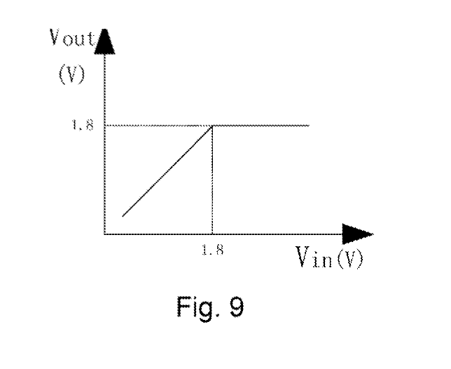

FIG. 9 is a graph of input-output characteristics of the low-dropout regulator circuit used in the present invention. It can be seen from the graph of input-output characteristics that, when the value of Vref is higher than over the ON voltage of the threshold unit and the threshold unit is thus turned on, the graph of input-output characteristics of the low-dropout regulator circuit used in the present invention is completely the same as the graph of input-output characteristics of the existing low-dropout regulator circuit illustrated in FIG. 2. That is, a structure of connecting in series a first threshold unit and a second threshold unit to branches of the first voltage dividing resistor and the second voltage dividing resistor, respectively, will have no influence to the performance of the low-dropout regulator circuit.

According to the threshold properties of the unidirectional conduction device (for example, a diode or a triode), when there is external constant current flowing through the threshold unit device, the threshold unit device may come into three different operating regions including a sub-threshold region, a linear region and a saturation region, depending upon the size of the external constant current. The field to which the present invention relates is the filed of radio frequency identification tag chips with ultra-low power consumption. The current in the circuit is an order of magnitude less than 1 uA. In the context of current of this order of magnitude, the threshold unit device is in the sub-threshold region. The impedance equivalence of the threshold unit device in the sub-threshold region will be explained in the following discussion.

Taking a diode as an example, the equivalent resistance of the diode is a difference in voltage across its P-N junction divided by current flowing through the P-N junction. In the connection way of the diode used in the present application, the current flowing through the P-N junction is a constant current externally input from the P-N junction. The typical current of one branch in the passive RFID tag chip with ultra-low power consumption is 100 nA. When an external current flows through the P-N junction, a resulting difference in voltage across the P-N junction is the threshold ON voltage of the P-N junction, the typical value of which is 0.7V. Hence, the equivalent resistance of the diode is 0.7V/100 nA=7 MΩ. For a logical process of 0.18 μm, the size of a diode having a resistance of 7 MΩ may be (2 μm)², i.e. an area of 4 μm². In contrast, if a resistor made of common polysilicon material is used, in order to achieve a resistance of 7 MΩ, there must be 0.7 million resistor squares on the basis of its typical square resistance of 10 ohm/square. If the size of a side of a resistor square is set as 500 nm, the 0.7 million resistor squares will occupy 700000*500 nm*500 nm=1.75×10⁵ um². That is, the area occupied by a diode having a resistance of 7 MΩ may be almost negligible with respect to that occupied by a resistor having a resistance of 7 MΩ. It can thus be seen that, when a same function is to be realized by using diodes and resistors, respectively, under the same power consumption, the circuit area occupied by using diodes will be greatly reduced, so that the overall production cost of the chip is reduced.

Taking a triode as an example, the equivalent resistance of the diode is a difference in voltage between its source and drain ends divided by current flowing through a channel formed between the source and the drain. In the present application, the gate of the triode is in short circuit with the drain thereof. That is, for triodes, a same connecting way as for diodes is used, and the current flowing through the channel formed between the source and drain of the triode is a constant current externally input. The typical current in one branch of the passive RFID tag chip with ultra-low power consumption is 100 nA. When an external current flows through the channel, duo to the special connecting way as for diodes, a difference in voltage between the source and the drain is the threshold ON voltage of the MOS transistor, the typical value of which is 0.7V. Therefore, the equivalent resistance of the MOS transistor is 0.7V/100 nA=7 MΩ. For a logical process of 0.18 μm, the size of the channel of a triode having a resistance of 7 MΩ may be 1 μm×0.18 μm, i.e. an area of 0.18 μm². In contrast, if a resistor made of common polysilicon material is used, in order to achieve a resistance of 7 MΩ, 1.75×10⁵ μm² will be occupied. That is, the area occupied by a triode having resistance of 7 MΩ may be almost negligible with respect to that occupied by a resistor having a resistance of 7 MΩ. It can thus be seen that, when a same function is to be realized by using triodes and resistors, respectively, under the same power consumption, the circuit area occupied by using triodes will be greatly reduced, so that the overall production cost of the chip is reduced.

We claim:

1. A low-dropout regulator circuit with ultra-low power consumption, comprising an error-correction differential amplifier, an MOS transistor, a first voltage dividing resistor and a second voltage dividing resistor, a negative input end of the error-correction differential amplifier being connected to a bandgap reference voltage, a positive input end of the error-correction differential amplifier being grounded through the second voltage dividing resistor, an output end of the error-correction differential amplifier being connected to a gate of the MOS transistor, a source of the MOS transistor and a power input end of the error-correction differential amplifier being connected to a power input, respectively, a drain of the MOS transistor being connected to the positive input end of the error-correction differential amplifier through the first voltage dividing resistor, characterized in that,
the low-dropout regulator circuit further comprises:
a first threshold unit connected between the positive input end of the error-correction differential amplifier and the first voltage dividing resistor, the first threshold unit being configured to reduce a difference in voltage from the positive input end of the error-correction differential amplifier to a voltage output end; and
a second threshold unit between the positive input end of the error-correction differential amplifier and the second voltage dividing resistor, the second threshold unit being configured to reduce a difference in voltage from the positive input end of the error-correction differential amplifier to a GND end.

2. The low-dropout regulator circuit with ultra-low power consumption according to claim 1, characterized in that the first threshold unit is at least one diode, in the at least one diode, a cathode end of any one diode is connected to an anode end of an adjacent diode to form a series structure, an anode end of a first diode is connected to the first voltage dividing resistor as an input end of the first threshold unit, and a cathode end of a last diode is connected to the positive input end of the error-correction differential amplifier as an output end of the first threshold unit;
the second threshold unit is at least one diode, in the at least one diode of the second threshold unit, a cathode end of any one diode is connected to an anode end of an adjacent diode to form a series structure, an anode end of a first diode is connected to the positive input end of the error-correction differential amplifier as an input end of the second threshold unit, and a cathode end of a last diode is connected to the second voltage dividing resistor as an output end of the second threshold unit; and
the number of diodes in the first threshold unit is the same as that of diodes in the second threshold unit.

3. The low-dropout regulator circuit with ultra-low power consumption according to claim 1, characterized in that the first threshold unit is at least one P-type MOS transistor, in the at least one P-type MOS transistor, a drain end of any one P-type MOS transistor is connected to a source end of an adjacent P-type MOS transistor to form a series structure, a gate of each of the P-type MOS transistors is connected to a drain thereof, a source of a first P-type MOS transistor is connected to the first voltage dividing resistor as an input end of the first threshold unit, and a drain of a last P-type MOS transistor is connected to a positive input end of the error-correction differential amplifier as an output end of the first threshold unit;
the second threshold unit is at least one P-type MOS transistor, in the at least one P-type MOS transistor of the second threshold unit, a drain end of any one P-type MOS transistor is connected to a source end of an adjacent P-type MOS transistor to form a series structure, a gate of each of the P-type MOS transistors is connected to a drain thereof, a source of a first P-type MOS transistor is connected to the positive input end of the error-correction differential amplifier as an input end of the second threshold unit, and a drain of a last P-type MOS transistor is connected to the second voltage dividing resistor as an output end of the second threshold unit; and
the number of P-type MOS transistors in the first threshold unit is the same as that of P-type MOS transistors in the second threshold unit.

4. The low-dropout regulator circuit with ultra-low power consumption according to claim 1, characterized in that the first threshold unit is at least one P-type MOS transistor, in the at least one P-type MOS transistor, a drain end of any one P-type MOS transistor is connected to a source end of an adjacent P-type MOS transistor to form a series structure, a source of a first P-type MOS transistor is connected to the first voltage dividing resistor as an input end of the first threshold unit, a drain of a last P-type MOS transistor is connected to the positive input end of the error-correction differential amplifier as an output end of the first threshold unit, and gate of each of the P-type MOS transistors is connected to a drain of the last P-type MOS transistor;
the second threshold unit is at least one P-type MOS transistor, in the at least one P-type MOS transistor of the second threshold unit, a drain end of any one P-type MOS transistor is connected to a source end of an adjacent P-type MOS transistor to form a series structure, a source of a first P-type MOS transistor is connected to the positive input end of the error-correction differential amplifier as an input end of the second threshold unit, a drain of a last P-type MOS transistor is connected to the second voltage dividing resistor as an output end of the second threshold unit, and a gate of each of the P-type MOS transistors is connected to a drain of the last P-type MOS transistor;
the number of P-type MOS transistors in the first threshold unit is the same as that of P-type MOS transistors in the second threshold unit.

5. The low-dropout regulator circuit with ultra-low power consumption according to claim 1, characterized in that the first threshold unit is at least one N-type MOS transistor, in the at least one N-type MOS transistor, a source end of any one N-type MOS transistor is connected to a drain of an adjacent N-type MOS transistor to form a series structure, gate of each of the N-type MOS transistors is connected to a drain thereof, a drain of a first N-type MOS transistor is connected to the first voltage dividing resistor as an input end of the first threshold unit, and a source of a last N-type MOS transistor is connected to the positive input end of the error-correction differential amplifier as an output end of the first threshold unit;
the second threshold unit is at least one N-type MOS transistor, in the at least one N-type MOS transistor of the second threshold unit, a source end of any one N-type MOS transistor is connected to a drain end of an adjacent N-type MOS transistor to form a series structure, gate of each of the N-type MOS transistors is connected to a drain thereof, a drain of a first N-type MOS transistor is connected to the positive input end of the error-correction differential amplifier as an input end of the second threshold unit, and a source of a last N-type MOS transistor is connected to the second voltage dividing resistor as an output end of the second threshold unit; and
the number of N-type MOS transistors in the first threshold unit is the same as that of N-type MOS transistors in the second threshold unit.

6. The low-dropout regulator circuit with ultra-low power consumption according to claim 1, characterized in that the first threshold unit is at least one N-type MOS transistor, in the at least one N-type MOS transistor, a source end of any one N-type MOS transistor is connected to a drain end of an adjacent N-type MOS transistor to form a series structure, a drain of a first N-type MOS transistor is connected to the first voltage dividing resistor as an input end of the first threshold unit, a source of a last N-type MOS transistor is connected to the positive input end of the error-correction differential amplifier as an output end of the first threshold unit, and gate of each of the N-type MOS transistors is connected to a drain of the first N-type MOS transistor;
the second threshold unit is at least one N-type MOS transistor, in the at least one N-type MOS transistor of the second threshold unit, a source end of any one N-type MOS transistor is connected to a drain end of an adjacent N-type MOS transistor to form a series structure, a drain of a first N-type MOS transistor is connected to the positive input end of the error-correction differential amplifier as an input end of the second threshold unit, a source of a last N-type MOS transistor is connected to the second voltage dividing resistor as an output end of the second threshold unit, and gate of each of the N-type MOS transistors is connected to a drain of the first N-type MOS transistor;
the number of N-type MOS transistors in the first threshold unit is the same as that of N-type MOS transistors in the second threshold unit.

7. A radio frequency identification tag, characterized in that the radio frequency identification tag comprises the low-dropout regulator circuit with ultra-low power consumption according to claim 1.

8. A radio frequency identification tag, characterized in that the radio frequency identification tag comprises the low-dropout regulator circuit with ultra-low power consumption according to claim 2.

9. A radio frequency identification tag, characterized in that the radio frequency identification tag comprises the low-dropout regulator circuit with ultra-low power consumption according to claim 3.

10. A radio frequency identification tag, characterized in that the radio frequency identification tag comprises the low-dropout regulator circuit with ultra-low power consumption according to claim 4.

11. A radio frequency identification tag, characterized in that the radio frequency identification tag comprises the low-dropout regulator circuit with ultra-low power consumption according to claim 5.

12. A radio frequency identification tag, characterized in that the radio frequency identification tag comprises the low-dropout regulator circuit with ultra-low power consumption according to claim 6.
